(19) United States
(12) Patent Application Publication
(10) Pub. No.: US 2013/0088533 A1
(43) Pub. Date: Apr. 11, 2013

(54) DRIVING METHOD OF BLUE PHASE LIQUID CRYSTAL DISPLAY APPARATUS

(71) Applicants: INNOCOM TECHNOLOGY (SHENZHEN) CO., LT, Shenzhen City (CN); CHIMEI INNOLUX CORPORATION, Miao-Li County (TW)

(72) Inventors: Chung-Ping LI, Miao-Li County (TW); Hsu-Kuan HSU, Miao-Li County (TW); Ming-Chuan CHIH, Miao-Li County (TW)

(73) Assignees: CHIMEI INNOLUX CORPORATION, Miao-Li County (TW); INNOCOM TECHNOLOGY (SHENZHEN) CO., LTD, Shenzhen City (CN)

(21) Appl. No.: 13/633,354

(22) Filed: Oct. 2, 2012

(30) Foreign Application Priority Data
Oct. 11, 2011 (TW) 100136813

(51) Int. Cl. G09G 3/36

(52) U.S. Cl. 345/691; 345/690; 345/88

(57) ABSTRACT

A driving method of a blue phase liquid crystal (BPLC) display apparatus cooperated with a BPLC display apparatus having at least one data line, at least one scan line and at least one pixel comprises the steps of: transmitting a first gray level voltage to the pixel through the data line; transmitting a first recovery voltage to the pixel through the data line; and transmitting a first black frame insertion voltage to the pixel through the data line, wherein the absolute value of the first recovery voltage is higher than those of the first gray level voltage and the first black frame insertion voltage. The invention can diminish the dark-state leakage of the BPLC display apparatus.

### CROSS REFERENCE TO RELATED APPLICATIONS

This Non-provisional application claims priority under 35 U.S.C. §119(a) on Patent Application No(s). 100136813 filed in Taiwan, Republic of China on Oct. 11, 2011, the entire contents of which are hereby incorporated by reference.

### BACKGROUND OF THE INVENTION

1. Field of Invention

The invention relates to a driving method of a display apparatus and, in particular, to a driving method of a blue phase liquid crystal display apparatus.

2. Related Art

The blue phase liquid crystal (BPLC) is a self-assembly three-dimensional photonic crystal structure, existing between the isotropic phase and the cholesteric phase. The BPLC is featured by a 3D crystalline characteristic while showing a liquid property, and besides, the lattice parameter of the BPLC is easily changeable, so that it becomes an excellent tunable photonic crystal providing various optical-electronic properties. Therefore, the BPLC can be applied to a stereoscopic display apparatus. Furthermore, compared with the conventional liquid crystal display technology, the BPLC display apparatus is capable of high LC response time with a wide viewing angle and needn't be configured with alignment layers. Hence, it has been more focused on and researched by the industry recently. However, the blue phase liquid crystals with different crystalline orientations have different optical-electronic properties under the application of an electric field, and the BPLC is submitted to the hysteresis effect, both of which cause the BPLC display apparatus image retention (IR).

In the present research of the LCD apparatus, the hysteresis effect of the BPLC apparatus is becoming a big subject for the optical performance. Although the conventional dark-state black frame insertion can solve the hysteresis problem of the BPLC to enhance the contrast and light transmittance of the display apparatus, it can not diminish the dark-state leakage of the BPLC display apparatus so that the dark-state transmittance of the BPLC display apparatus is unstable, affecting the contrast seriously.

Therefore, it is an important subject to provide a driving method that can diminish the dark-state leakage of the BPLC display apparatus.

### SUMMARY OF TILE INVENTION

In view of the foregoing subject, an objective of the invention is to provide a driving method that can diminish the dark-state leakage of the BPLC display apparatus.

To achieve the above objective, according to the invention, a driving method of a blue phase liquid crystal (BPLC) display apparatus cooperated with a BPLC display apparatus having at least one data line, at least one scan line and at least one pixel comprises the steps of transmitting a first gray level voltage to the pixel through the data line; transmitting a first recovery voltage to the pixel through the data line; and transmitting a first black frame insertion voltage to the pixel through the data line, wherein the absolute value of the first recovery voltage is higher than those of the first gray level voltage and the first black frame insertion voltage.

In one embodiment, when the transmission of the first recovery voltage follows the transmission of the first gray level voltage, the first gray level voltage and the first recovery voltage have opposite polarities.

In one embodiment, the first gray level voltage, the first recovery voltage, and the first black frame insertion voltage are transmitted in sequence during a frame time.

In one embodiment, the ratio of the duty time of the first gray level voltage to the duty time of the first recovery voltage is between 1:1˜1:0.025 during a frame time.

In one embodiment, the ratio of the duty time of the first recovery voltage to the duty time of the first black frame insertion voltage is between 1:1˜1:0.025 during a frame time.

In one embodiment, the driving method further comprises: transmitting a second gray level voltage to the pixel through the data line.

In one embodiment, the driving method further comprises: transmitting a second gray level voltage and a second recovery voltage to the pixel through the data line.

In one embodiment, the driving method further comprises: transmitting a second gray level voltage and a second black frame insertion voltage to the pixel through the data line.

In one embodiment, the driving method further comprises: transmitting a second gray level voltage, a second recovery voltage, and a second black frame insertion voltage to the pixel through the data line.

In one embodiment, the first gray level voltage and the second gray level voltage have opposite polarities.

In one embodiment, the first recovery voltage and the second recovery voltage have opposite polarities.

In one embodiment, the first black frame insertion voltage and the second black frame insertion voltage have opposite polarities.

In one embodiment, the first gray level voltage, the second gray level voltage, the first recovery voltage, the second recovery voltage, the first black frame insertion voltage, and the second black frame insertion voltage are transmitted in sequence during the two consecutive frame times.

In one embodiment, the first gray level voltage, the second gray level voltage, the first recovery voltage, the first black frame insertion voltage, and the second black frame insertion voltage are transmitted in sequence during the two consecutive frame times.

In one embodiment, the first gray level voltage, the second gray level voltage, the second recovery voltage, the first black frame insertion voltage, and the second black frame insertion voltage are transmitted in sequence during the two consecutive frame times.

In one embodiment, the first gray level voltage, the second gray level voltage, the first recovery voltage, and the first black frame insertion voltage are transmitted in sequence during the two consecutive frame times.

In one embodiment, the first gray level voltage, the second gray level voltage, the second recovery voltage, and the second black frame insertion voltage are transmitted in sequence during the two consecutive frame times.

In one embodiment, the first recovery voltage or the, second recovery voltage is between 15V and 60V.

In one embodiment, the absolute value of the first recovery voltage is between 1.2 times and 4 times of the absolute value of the first gray level voltage or the first black frame insertion voltage.

As mentioned above, according to the driving method of the BPLC display apparatus of the invention, the first gray level voltage is transmitted to the pixel through the data line, the first recovery voltage is transmitted to the pixel through the data line, and the first black frame insertion voltage is transmitted to the pixel through the data line. Besides, the absolute value of the first recovery voltage is higher than those of the first gray level voltage and the first black frame insertion voltage. Thereby, following the first gray level voltage, the first recovery voltage with higher level is transmitted so that the BPLC can be furnished with larger recovery force to more easily return to the optically isotropic sphere state, diminishing the dark-state leakage of the LCD apparatus and also enhancing the stability of the dark-state transmittance.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic diagram of a blue phase liquid crystal (BPLC) display apparatus according to an embodiment of the invention;

FIG. 1B is a schematic side-view diagram of a BPLC display panel as shown in FIG. 1A;

FIG. 1C is a schematic side-view diagram of another BPLC display panel;

FIG. 2 is a flow chart of a driving method of the BPLC display apparatus of the invention;

FIG. 3A is a schematic diagram showing the time sequence of the signals of the driving method of the invention for driving the BPLC display apparatus;

FIGS. 3B to 3D are schematic diagrams showing other time sequences of the signals of the driving method of the invention for driving the BPLC display apparatus; and

FIG. 4 is a schematic diagram showing the dark-state transmittance resulting from the driving method of the invention for driving the BPLC display apparatus.

### DETAILED DESCRIPTION OF THE INVENTION

The present invention will be apparent from the following detailed description, which proceeds with reference to the accompanying drawings, wherein the same references relate to the same elements.

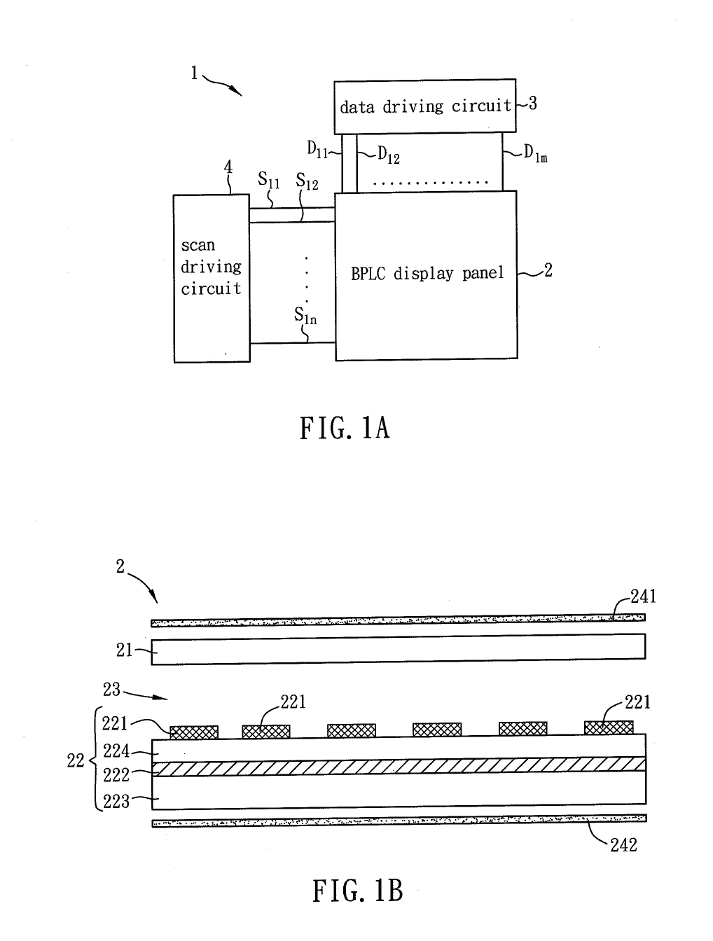

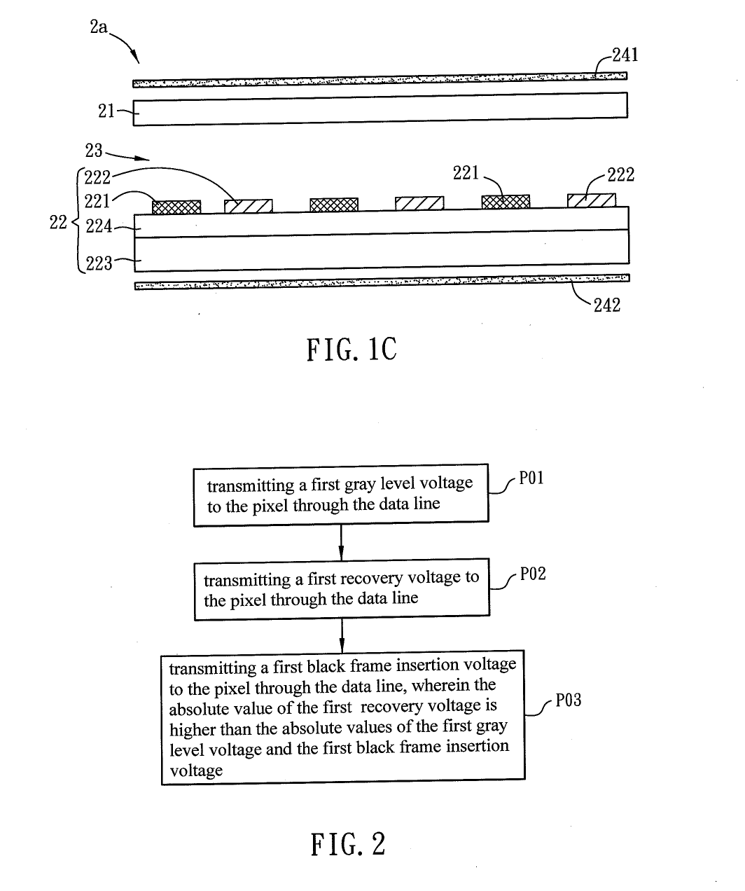

FIG. 1A is a schematic diagram of a blue phase liquid crystal (BPLC) display apparatus 1 according to an embedment, FIG. 1B is a schematic side-view diagram of a BPLC display panel 2 as shown in FIG. 1A, and FIG. 2 is a flow chart of a driving method of the BPLC display apparatus of the invention.

The driving method of the BPLC display apparatus is cooperated with the BPLC display apparatus 1. As shown in FIG. 1A, the BPLC display apparatus 1 includes a BPLC display panel 2, a data driving circuit 3, a scan driving circuit 4, at least one data line, at least one scan line, and at least one pixel. In the embodiment, the BPLC display apparatus 1 is instanced as having a plurality of pixels (not shown in FIG. 1), a plurality of scan lines S11˜S1n and a plurality of data lines D11˜D1m. The scan lines S11˜S1n and the data lines D11˜D1m are intersected with each other to define the pixel array. Besides, the BPLC display panel 2 is electrically connected with the data driving circuit 3 through the data lines D11˜D1m, and with the scan driving circuit 4 through the scan lines S11˜S1n.

As shown in FIG. 1B, the BPLC display panel 2 of this embodiment is instanced as a fringe field switching (FFS) LCD panel. Otherwise, the BPLC display panel 2 can be an in-plane switch (IPS) LCD panel, such as a BPLC display panel 2a as shown in FIG. 1C, or other kinds of the LCD panel.

The BPLC display panel 2 includes a first substrate 21, a second substrate 22, and a BPLC layer 23 (the BPLC molecules are not shown in the figure). The first substrate 21 can be a color filter substrate or a transparent glass substrate, and the second substrate 22 is an active matrix substrate, such as a thin film transistor (TFT) substrate, which is disposed opposite to the first substrate 21. The BPLC layer 23 is sandwiched in between the first and second substrates 21 and 22, and includes a liquid crystal material having blue phase, a polymer and a chiral dopant, wherein monomers are polymerized to become the polymer by the illumination of the ultraviolet, thereby stabilizing the BPLC's structure to increase the temperature range for the existence of the BPLC as well as the operational temperature range of the BPLC. The polymer can include, for example, acrylate, methacrylate, or epoxy, or their combinations. In the embodiment, the polymer's material is not limited.

The second substrate 22 includes a pixel electrode 221, an electrode layer 222, and a transparent substrate 223. The pixel electrode 221 and the electrode layer 222 are disposed on the transparent substrate 223. Herein, the electrode layer 222 is a common electrode layer. The second substrate 22 can further include an insulating layer 224, which is disposed between the pixel electrode 221 and the electrode layer 222 to insulate them from each other for preventing the short circuit. When the TFT is turned on, the gray level voltage can be transmitted to the pixel electrode 221 so that an electric field substantially in parallel with the transparent substrate 223 is formed between the pixel electrode 221 and the electrode layer 222 (common electrode layer), thereby driving the molecules of the PBLC layer 23 to rotate for modulating the light. To be note, in the embodiment, the pixel electrode 221 is disposed on the insulating layer 224 while the electrode layer 222 (common electrode layer) is disposed below the insulating layer 224. However, in other embodiments, the electrode layer 222 (common electrode layer) can be disposed on the insulating layer 224 while the pixel electrode 221 is disposed below the insulating layer 224.

Besides, the BPLC display panel 2 can further include two polarizing plates 241 and 242, which are disposed at the respective outsides of the first and second substrates 21 and 22. As shown in FIG. 1B, the polarizing plate 241 is disposed on the top side of the first substrate 21, and the polarizing plate 242 is disposed on the bottom side of the second substrate 22. By the polarizing plates 241 and 242 whose polarization axes have a difference of 90 degrees, the light emitted by the backlight module can be prevented from being exiting from the display panel, and the LC can be rotated by controlling the magnitude of the electric field to modulate the light so that the display panel can display images.

As shown in FIGS. 1A and 2, the driving method of the BPLC display apparatus includes the steps of: transmitting a first gray level voltage to the pixel through the data line (P01); transmitting a first recovery voltage to the pixel through the data line (P02); and transmitting a first black frame insertion voltage to the pixel through the data line, wherein the absolute value of the first recovery voltage is higher than the absolute values of the first gray level voltage and the first black frame insertion voltage (P03).

As below, refer the relative figures to further illustrate the driving method of the invention.

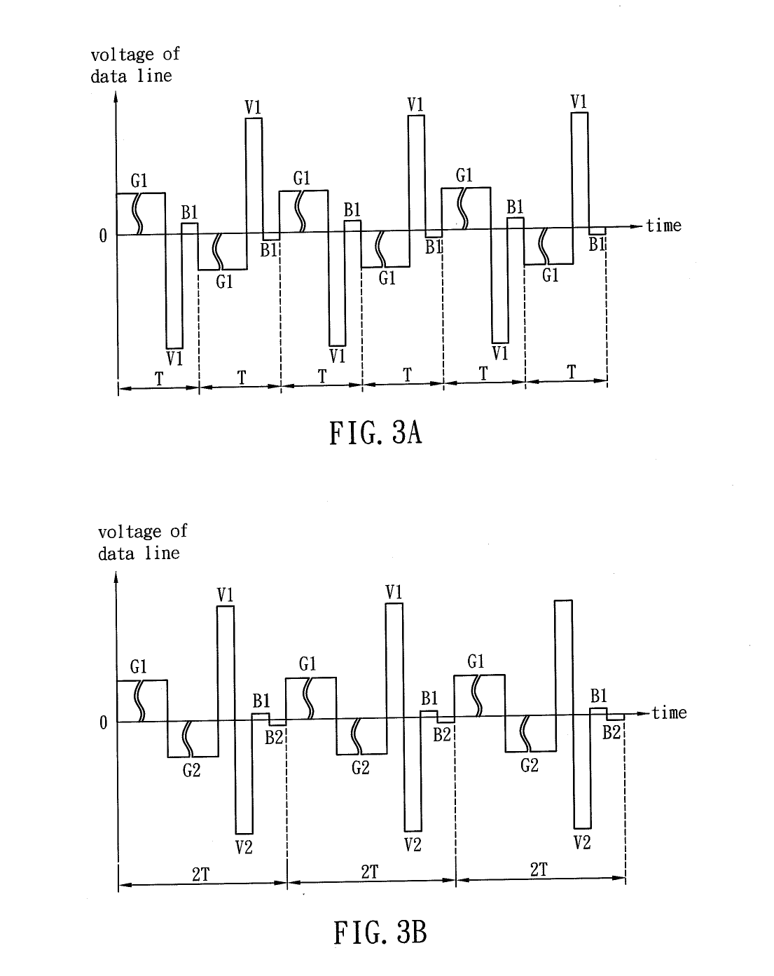

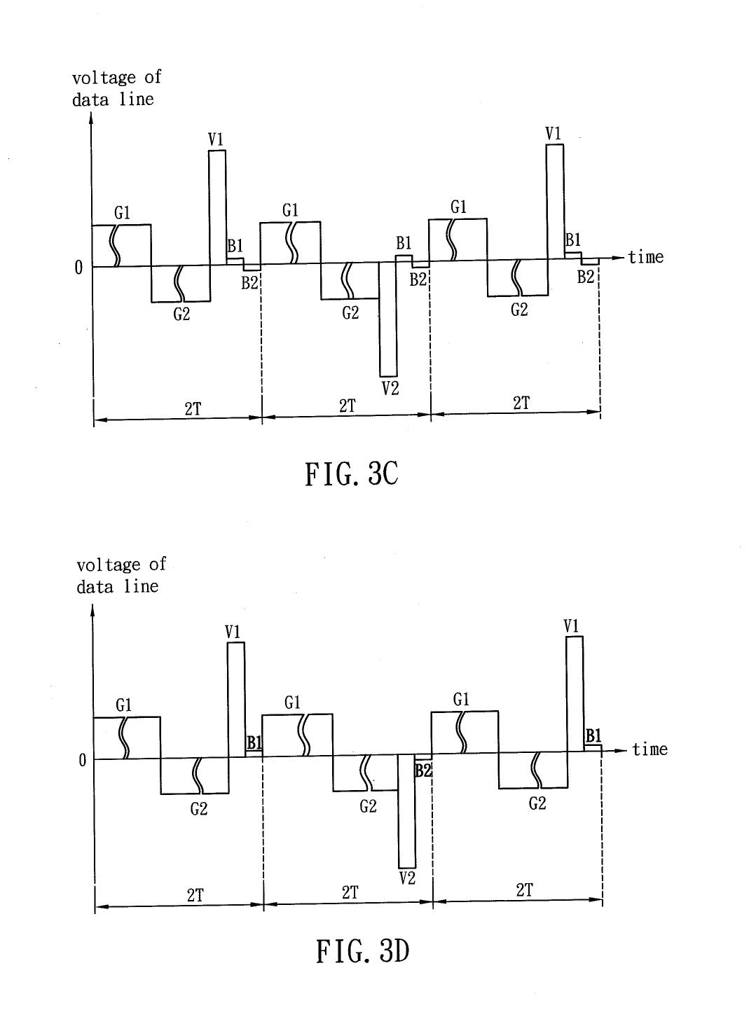

FIG. 3A is a schematic diagram showing the time sequence of the signals of the driving method for driving the BPLC display apparatus 1. As shown in FIGS. 2 and 3A, in the step P01, the first gray level voltage G1 is transmitted to the pixel through the data line. In detail, the scan driving circuit 4 transmits the enabling signals to sequentially enable the scan lines S11˜S1n, while the data driving circuit 3 transmits the first gray level voltages G1 to the pixels through the data lines D11˜D1m so that the BPLC display apparatus 1 can display images. Herein, the first gray level voltage G1 has positive polarity. To be noted, the first gray level voltages G1 as shown in FIG. 3A represent the gray level voltages transmitted to the all pixels by the data driving circuit 3 during a frame time. In other words, the first gray level voltages G1 are the data voltages transmitted by the data driving circuit 3 when the scan driving circuit 4 sequentially enables the all scan lines S11˜S1n.

In the step P02, the first recovery voltage V1 is transmitted to the pixel through the data line. Herein, when the scan lines S11˜S1n are enabled at the same time, the first recovery voltages V1 are transmitted to the all pixels simultaneously. The first recovery voltages V1 have negative polarity. The first recovery voltage V1 can make the BPLC display apparatus 1 display white images.

In the step P03, the first black frame insertion voltage B1 is transmitted to the pixel through the data line. Herein, when the scan lines S11˜S1n are enabled at the same time, the first black frame insertion voltages B1 are transmitted to the all pixels simultaneously. The first black frame insertion voltage B1 is related to the conventional black frame insertion technology, making the BPLC display apparatus 1 display black images to resist the hysteresis effect of the BPLC. The first black frame insertion voltage B1 substantially can be zero or other preset voltages.

The absolute value of the first recovery voltage V1 is higher than those of the first gray level voltage G1 and the first black frame insertion voltage B1, and preferably between 1.2 times and 4 times of the absolute value of the first gray level voltage G1 or the first black frame insertion voltage B1. In other words, the first recovery voltage V1 has higher voltage. With respective driving characteristics possessed by BPLC display apparatuses, the first recovery voltage V1 can be set between 15V and 60V for example. Anyhow, the first recovery voltage V1 is preferably between 1.2 times and 4 times of the absolute value of the first gray level voltage G1 or the first black frame insertion voltage B1. The first recovery voltage V1 can make the BPLC display apparatus 1 display white images, thereby diminishing the dark-state leakage of the BPLC of the BPLC display apparatus 1.

The possible reason that the first recovery voltage V1 can diminish the dark-state leakage of the BPLC is described as below. The image can not be driven to a complete dark-state due to the hysteresis effect of the BPLC, but however, when a higher driving voltage (the first recovery voltage V1) is applied, the lattice sphere with an optical isotropy of the BPLC is drawn out to become an ellipsoid that is featured by birefringence and constrained by the polymer. Then, when the driving voltage is done, the ellipsoid can be deformed back to the sphere by the elastic recovery force. In other words, by the driving of the first recovery voltage V1, the ellipsoid can have higher recovery force. Therefore, after the driving of the first recovery voltage V1 finishes, the ellipsoid is easier to return to the optically isotropic sphere, which makes the following black image displayed by the black frame insertion voltage darker so that the dark-state leakage of the BPLC can be diminished. Besides, the driving of the first recovery voltage V1 may transform the lattice structure of the BPLC into the nematic phase, so once the driving of the first recovery voltage V1 finishes, the lattice structure returns, without the hysteresis effect, to the optically isotropic sphere state that is constrained by the polymer, thereby also diminishing the dark-state leakage of the BPLC.

As shown in FIG. 3A, in the embodiment, the first gray level voltage G1, the first recovery voltage V1 and the first black frame insertion voltage B1 are transmitted in sequence during a frame time T. The first recovery voltage V1 closely follows the transmission of the first gray level voltage G1, and they have opposite polarities, causing the polarity change of the electric field to prevent the LC molecules from being polarized. If the LC molecules are polarized, they can not rotate in response to the changes of the electric field.

Besides, during a frame time T, the ratio of the duty time of the first gray level voltage G1 to the duty time of the first recovery voltage V1 can be set between 1:1 and 1:0.025. During a frame time T, the ratio of the duty time of the first recovery voltage V1 to the duty time of the first black frame insertion voltage B1 can be set between 1:1 and 1:0.025. The duty times of the first gray level voltage G1, the first recovery voltage V1 and the first black frame insertion voltage B1 can be varied according to different BPLC display apparatus.

FIG. 3B is a schematic diagram showing another time sequence of the signals of the driving method for driving the BPLC display apparatus 1. As shown in FIG. 3B, the driving method can further include the steps of transmitting a second gray level voltage G2 to the pixel through the data line; transmitting a second recovery voltage V2 to the pixel through the data line; and transmitting a second black frame insertion voltage B2 to the pixel through the data line. The absolute value of the second recovery voltage V2 is higher than those of the second gray level voltage G2 and the second black frame insertion voltage B2, and preferably between 1.2 times and 4 times of the absolute value of the second gray level voltage G2 or the second black frame insertion voltage B2. The absolute values of the first recovery voltage V1 and the second recovery voltage V2 can be the same or different, and herein they are the same for example. The second black frame insertion voltage B2 is related to the conventional black frame insertion technology, and can be substantially zero.

In the embodiment, during the two consecutive frame times T, the first and second gray level voltages G1 and G2, the first and second recovery voltages V1 and V2, and the first and second black frame insertion voltages B1 and B2 are transmitted in sequence. The ratio of the duty times of the second gray level voltage G2, the second recovery voltage V2 and the second black frame voltage B2 can be set differently in response to different BPLC display apparatuses. The duty times of the first recovery voltage V1 and the second recovery voltage V2 can be the same or different, and they are the same in the embodiment for example. The first gray level voltage G1 and the second gray level voltage G2 have opposite polarities. The duty times of the first gray level voltage G1 and the second gray level voltage G2 can be arranged adjacent to each other or separated by an interval, and herein they are adjacent to each other for example. The first recovery voltage V1 and the second recovery voltage V2 have opposite polarities, the first black frame insertion voltage B1 and the second black frame insertion voltage B2 have opposite polarities, and the second gray level voltage G2 and the first recovery voltage V1 have opposite polarities.

FIG. 3C is a schematic diagram showing another time sequence of the signals of the driving method for driving the BPLC display apparatus of the invention. As shown in FIG. 3C, during the two consecutive frame times T, the first and second gray level voltages G1 and G2, the first recovery voltage V1, and the first and second black frame insertion voltages B1 and B2 are transmitted in sequence. Then, during the next two consecutive frame times T, the first and second gray level voltages G1 and G2, the second recovery voltage V2, and the first and second black frame insertion voltages B1 and B2 are transmitted in sequence. The duty times of the first recovery voltage V1 and the second recovery voltage V2 can be the same or different, and they are the same in the embodiment for example. The first gray level voltage G1 and the second gray level voltage G2 have opposite polarities. The first recovery voltage V1 and the second recovery voltage V2 have opposite polarities. The second gray level voltage G2 and the first recovery voltage V1 have opposite polarities.

FIG. 3D is a schematic diagram showing another time sequence of the signals of the driving method for driving the BPLC display apparatus of the invention. As shown in FIG. 3D, during the two consecutive frame times T, the first and second gray level voltages G1 and G2, the first recovery voltage V1, and the first black frame insertion voltage B1 are transmitted in sequence. Then, during the next two consecutive frame times T, the first and second gray level voltages G1 and G2, the second recovery voltage V2, and the second black frame insertion voltage B2 are transmitted in sequence. The duty times of the first recovery voltage V1 and the second recovery voltage V2 can be the same or different, and they are the same in the embodiment for example. The first gray level voltage G1 and the second gray level voltage G2 have opposite polarities. The first recovery voltage V1 and the second recovery voltage V2 have opposite polarities. The second gray level voltage G2 and the first recovery voltage V1 have opposite polarities.

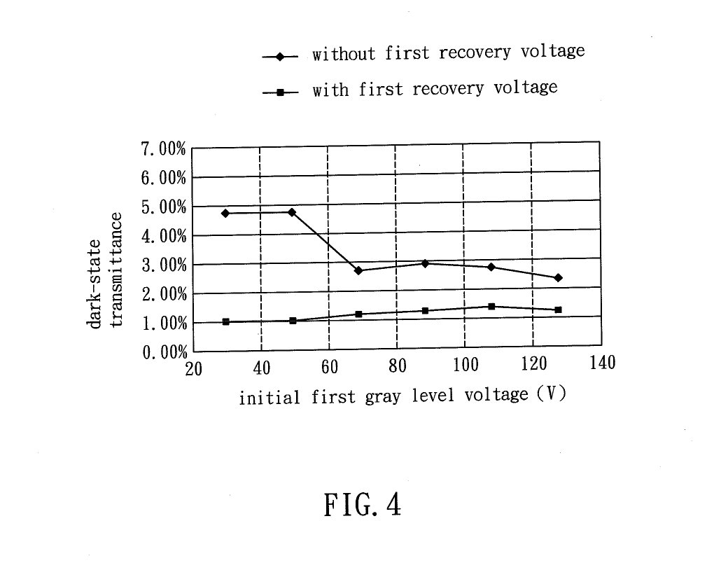

FIG. 4 is a schematic diagram showing the dark-state transmittance resulting from the driving method of the invention for driving the BPLC display apparatus 1, including the vertical coordinate representing the dark-state transmittance and the horizontal coordinate representing the initial first gray level voltage. Herein, the BPLC display apparatus 1 is driven by the signals having the time sequence as shown in FIG. 3A.

The conventional black frame insertion technology has no first recovery voltage, wherein the black frame insertion voltage just follows the first gray level voltage. In the driving method of the invention, however, after inputting the first gray level voltage, the first recovery voltage and the black frame voltage are inputted in sequence, and the level of the first recovery voltage is higher than those of the black frame insertion voltage and the gray level voltage. In FIG. 4, the first recovery voltage V1 is 200V for example, which is measured in the case of the two adjacent pixel electrodes 221 (in FIG. 1B) having an interval larger than 10 μm.

As shown in FIG. 4, as to the conventional black frame insertion technology (i.e. without first recovery voltage), the dark-state transmittance is quite unstable with a range between 1.3%˜4.8% when the various first gray level voltages G1 as well as the following first black frame insertion voltages B1 (such as 1V) are inputted to drive the pixels. However, in the driving method of the invention, the dark-state transmittance is quite stable with a range between 1%˜1.3% when the various first gray level voltages G1 are inputted, and then the sequential first recovery voltages V1 and the first black frame insertion voltages B1 are inputted to drive the pixels. In the practical applications in consideration of the design of the driving circuit and the adoption of the liquid crystal material, the first recovery voltage can be set between 15V and 60V to diminish the dark-state leakage of the LCD apparatus and enhance the stability of the dark-state transmittance. Therefore, the driving method of the BPLC display apparatus of the invention can not only diminish the dark-state leakage of the LCD apparatus, but also enhance the stability of the dark-state transmittance.

In summary, according to the driving method of the BPLC display apparatus of the invention, the first gray level voltage is transmitted to the pixel through the data line, the first recovery voltage is transmitted to the pixel through the data line, and the first black frame insertion voltage is transmitted to the pixel through the data line. Besides, the absolute value of the first recovery voltage is higher than those of the first gray level voltage and the first black frame insertion voltage. Thereby, following the first gray level voltage, the first recovery voltage with higher level is transmitted so that the BPLC can be furnished with larger recovery force to more easily return to the optically isotropic sphere state, diminishing the dark-state leakage of the LCD apparatus and also enhancing the stability of the dark-state transmittance.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A driving method of a blue phase liquid crystal (BPLC) display apparatus cooperated with a BPLC display apparatus having at least one data line, at least one scan line and at least one pixel, comprising the steps of:
transmitting a first gray level voltage to the pixel through the data line;
transmitting a first recovery voltage to the pixel through the data line; and
transmitting a first black frame insertion voltage to the pixel through the data line, wherein the absolute value of the first recovery voltage is higher than those of the first gray level voltage and the first black frame insertion voltage.

2. The driving method as recited in claim 1, wherein when the transmission of the first recovery voltage follows the transmission of the first gray level voltage, the first gray level voltage and the first recovery voltage have opposite polarities.

3. The driving method as recited in claim 1, wherein the first gray level voltage, the first recovery voltage, and the first black frame insertion voltage are transmitted in sequence during a frame time.

4. The driving method as recited in claim 1, wherein the ratio of the duty time of the first gray level voltage to the duty time of the first recovery voltage is between 1:1˜1:0.025 during a frame time.

5. The driving method as recited in claim 1, wherein the ratio of the duty time of the first recovery voltage to the duty time of the first black frame insertion voltage is between 1:1˜1:0.025 during a frame time.

6. The driving method as recited in claim 1, further comprising:
transmitting a second gray level voltage to the pixel through the data line.

7. The driving method as recited in claim 1, further comprising:
transmitting a second gray level voltage and a second recovery voltage to the pixel through the data line.

8. The driving method as recited in claim 1, further comprising:
transmitting a second gray level voltage and a second black frame insertion voltage to the pixel through the data line.

9. The driving method as recited in claim 1, further comprising:
transmitting a second gray level voltage, a second recovery voltage, and a second black frame insertion voltage to the pixel through the data line.

10. The driving method as recited in claim 6, wherein the first gray level voltage and the second gray level voltage have opposite polarities.

11. The driving method as recited in claim 7, wherein the first recovery voltage and the second recovery voltage have opposite polarities.

12. The driving method as recited in claim 8, wherein the first black frame insertion voltage and the second black frame insertion voltage have opposite polarities.

13. The driving method as recited in claim 9, wherein the first gray level voltage, the second gray level voltage, the first recovery voltage, the second recovery voltage, the first black frame insertion voltage, and the second black frame insertion voltage are transmitted in sequence during the two consecutive frame times.

14. The driving method as recited in claim 9, wherein the first gray level voltage, the second gray level voltage, the first recovery voltage, the first black frame insertion voltage, and the second black frame insertion voltage are transmitted in sequence during the two consecutive frame times.

15. The driving method as recited in claim 14, wherein the first gray level voltage, the second gray level voltage, the second recovery voltage, the first black frame insertion voltage, and the second black frame insertion voltage are transmitted in sequence during the two consecutive frame times.

16. The driving method as recited in claim 9, wherein the first gray level voltage, the second gray level voltage, the first recovery voltage, and the first black frame insertion voltage are transmitted in sequence during the two consecutive frame times.

17. The driving method as recited in claim 16, wherein the first gray level voltage, the second gray level voltage, the second recovery voltage, and the second black frame insertion voltage are transmitted in sequence during the two consecutive frame times.

18. The driving method as recited in claim 7, wherein the first recovery voltage or the second recovery voltage is between 15V and 60V.

19. The driving method as recited in claim 1, wherein the absolute value of the first recovery voltage is between 1.2 times and 4 times of the absolute value of the first gray level voltage or the first black frame insertion voltage.
